(19) United States
(12) Patent Application Publication
(10) Pub. No.: US 2009/0297683 A1
(43) Pub. Date: Dec. 3, 2009

(54) A METHOD FOR FORTIFYING FOOD STUFF WITH PHYTONUTRIENTS AND FOOD PRODUCTS OBTAINED THEREBY

(75) Inventors: Morris Zelkha, Omer (IL); Dov Hartal, Tel Aviv (IL)

Correspondence Address: BROWDY AND NEIMARK, P.L.L.C.;624 NINTH STREET, NW, SUITE 300, WASHINGTON, DC, 20001-5303, US

(73) Assignee: Lycored Natural Products Industries Ltd., Beer-Sheva (IL)

(21) Appl. No.: 11/577,918

(22) PCT Filed: Oct. 26, 2004
(86) PCT No.: PCT/IL04/00974

§ 371 Date: Aug. 10, 2009

(51) Int. Cl. A23C 9/154; A23L 2/00; A23L 1/212

(52) U.S. Cl. 426/580; 426/590; 426/615

(57) ABSTRACT

The present invention provides a method for fortifying food stuff with an effective health-beneficial amount of tomato phytonutrients, wherein the flavor of said food stuff is not substantially effected by said tomato phytonutrients, comprising of adding to food stuff tomato oleoresin or components thereof in an amount which will not substantially affect the flavor of the food stuff. The present invention further discloses tomato phytonutrient fortified food stuff, wherein the flavor of said food stuff is not substantially effected by the tomato phytonutrients. The present invention further provides a method for obtaining the health benefits associated with the consumption of tomato phytonutrients, comprising of administering to a subject tomato-phytonutrient-fortified food stuff of the present invention.

### FIELD OF THE INVENTION

The present invention relates to the field of nutrition, particularly, to a method for fortifying food stuff with phytonutrients.

### BACKGROUND OF THE INVENTION

The health benefits associated with the consumption of various tomato phytonutrients are many and have been described in the literature. Said health benefits include, inter-alia, the prevention and treatment of; various types of cancer, cardiovascular diseases, opthamological disorders, fertility disorders and hepatic diseases. Furthermore, it has been acknowledged that tomato phytonutrients may be associated with the protection of DNA from DNA damage and may assist in repairing said damages. Furthermore, it has been acknowledged that the health benefits from the combination of tomato phytonutrients as they occur in the natural tomato are greater than the health benefits of the tomato components alone. That is to say that there is a synergistic effect in the combination. Accordingly, there is a great importance in consuming tomato phytonutrients in combination.

The health benefits associated with the consumption of tomato phytonutrients are primarily derived from the phytonutrients and combination thereof which are contained in the water-insoluble fraction of the tomato. In tomato processing a tomato may be separated to two fractions; a fraction containing the water soluble components of the tomato and a fraction containing the water insoluble components. There are various methods for obtaining said fractions of the tomato, however most processes are based on the basic operation of crushing the tomato and separating the solids from the liquid phase. The solid phase is referred to as pulp and the liquid phase is referred to as serum. The pulp is about 8% of the tomato and contains most of the water insoluble components. The pulp is a good source of tomato-water-insoluble phytonutrients. The pulp may contain a fraction of the water soluble components. The pulp may be processed in various methods depending on the desired product. For example, subjecting the pulp to extraction may provide tomato oleoresin, which contains tomato phytonutrients in a relatively high concentration.

Currently the methods for administering said tomato phytonutrients include consuming tomatoes and tomato products, and administration of nutritional supplements containing tomato phytonutrients, such as tablets, capsules and the like. However, these methods of administration are limited and require the subject to make a conscious effort to consume said means of administration. Alternatively, various foods may be fortified with tomato products in order to impart the health benefits of the tomato phytonutrients to the food. However, supplementation of foods with tomato products such as paste, juice and powder, in an effective dosage creates a problem by imparting to the product the typical tomato flavor and color. In order to supplement the food with an effective dose of tomato phytonutrients a substantial amount of tomato product is required which will impart to the food a tomato flavor, hence affecting the flavor of the food, which often is undesirable.

Thus, there is a long felt need for alternative methods for administering tomato phytonutrients in such a way that the food stuff which is the vehicle for the tomato phytonutrients is not affected by the flavor of said tomato phytonutrients.

It is therefore an objective of the present invention to provide a method for fortifying food stuffs with tomato phytonutrients wherein the flavor of the food stuff is not substantially affected by said tomato phytonutrients.

It is a further objective of the present invention to provide novel food stuffs which contain tomato phytonutrients in an effective dosage, wherein the flavor of said food stuff is not substantially effected by the tomato phytonutrients.

Other objectives of the invention will become apparent as the description proceeds.

### SUMMARY OF THE INVENTION

According to the present invention there is provided a method for fortifying food stuff with an effective health-beneficial amount of tomato phytonutrients, wherein the flavor of said food stuff is not substantially effected by said tomato phytonutrients, comprising of adding to food stuff tomato oleoresin or components thereof in an amount which will not substantially affect the flavor of the food stuff.

According to yet a further aspect of the present invention, tomato phytonutrient fortified food stuff is provided, wherein the flavor of said food stuff is not substantially effected by the tomato phytonutrients.

A further aspect of the present invention is to provide a method for obtaining the health benefits associated with the consumption of tomato phytonutrients, comprising of administering to a subject tomato-phytonutrient-fortified food stuff of the present invention.

### DETAILED DESCRIPTION OF THE INVENTION

The following description is illustrative of embodiments of the invention. The following description is not to be construed as limiting, it being understood that the skilled person may carry out many obvious variations to the invention.

Throughout the description, percentages of components are by weight, unless specifically noted differently. The term tomato phytonutrients relates to the components of the tomato which independently or in combination provide health benefits to the subject who consumes said phytonutrients. Throughout the description the term tomato oleoresin refers to the lipid fraction of the tomato which contains tomato phytonutrients which are not substantially soluble in water. The term “food stuff” relates to any food product or beverage, which includes inter alia food, baked products, processed foods, and beverages.

It has unexpectedly been found that food stuff may be fortified with tomato phytonutrients by adding tomato oleoresin or components thereof to said food stuff, in an amount that provides a health benefit and does not substantially affect the flavor of said food stuff. Tomato oleoresin and tomato components which are substantially insoluble in water contain relatively high concentrations of phytonutrients, e.g. lycopene, beta-carotene, phytoene, phytofluene, tocopherols, phospholipids and phytosterols. Hence, a relatively small amount of tomato oleoresin and water insoluble tomato components, hereinafter Tomato Components provide an effective amount of tomato phytonutrients. This allows for the use of a small amount of Tomato Components and oleoresin as a nutritionally fortifying additive for food stuff. Throughout the description the term tomato oleoresin also includes compositions which contain tomato oleoresin components. The term Tomato Components also encompasses tomato oleoresin.

According to an embodiment of the present method, tomato oleoresin is added to food stuff in various stages of food processing, according to the nature of the particular food and the processing employed. The oleoresin intended for being added to the food stuff may be prepared in various forms suitable for the intended food stuff. The oleoresin may be emulsified, solubilized, dissolved, encapsulated or micro-encapsulated in order to impart stability to the oleoresin during processing and storage or included in tomato fibers that contain tomato phytonutrients.

The amount of oleoresin or Tomato Components added to the food stuff is adjusted so that consumption of the food stuff provides an effective dosage of tomato phytonutrients in order to achieve the desired health benefit and the addition does not affect the typical flavor of the food. The amount varies according to the type of food and to the size of the serving. According to a particular embodiment of the invention, the amount of oleoresin and Tomato Components to be added to food stuffs is determined based on its lycopene content. Thus, initially the desired dosage of lycopene is determined for the intended food stuff and the amount of oleoresin, Tomato Component or composition containing them which is added, is calculated based on said dosage. The amount of other tomato phytonutrients added to the food stuff is dependent on the concentration of said phytonutrients in the Tomato Components which is employed as a source of said phytonutrients. The amount of oleoresin or Tomato Component in food stuff is preferably in the range that would provide a subject who is consuming said food stuffs with a daily intake in the range of 5 to 20 mg of lycopene.

In yet a further aspect of the invention fortified food stuff are provided, wherein said food stuff are fortified with tomato phytonutrients and the flavor of said food stuff is not substantially effected by said tomato phytonutrients. Said food stuff contain 0.5 mg to 20 mg of tomato lycopene per serving.

According to a further aspect of the present invention, the health benefits associated with the consumption of tomato phytonutrients, are provided to a subject by administering to said subject a tomato-phytonutrient-fortified food stuff as described above. Non-limiting examples of the health benefits which may be associated with the consumption of said fortified food stuff are: prevention and repair of DNA damage, prevention and treatment of; cardiovascular disorders, various types of cancer, opthamological disorders, fertility disorders and hepatic diseases. The food stuff is administered in a manner that provides the subject with an effective amount of tomato phytonutrients. The phytonutrients are introduced into the food product in the production process and become part of its composition without affecting its sensory properties. Thus food stuff that are not associated with the tomato, can be enriched with tomato phytonutrients and receive their beneficial effect on health without imparting tomato flavor to said food stuff.

Oleoresin suitable for use in the presently described invention may be obtained from tomatoes or tomato products. An example of commercially available tomato oleoresin is Lyc-O-Mato® by Lycored Natural Products Industries Ltd. Oleoresin suitable for the purposes of the present invention may further be provided in various compositions which contain oleoresin with further diluents, adjuvents and carrier.

The advantages of the present invention are incorporated in the enablement of the introduction of tomato phytonutrients with their beneficial effects on health, into a wide range of food stuff without substantially changing the flavor of said food stuff. Thus, the present invention further provides means for administering tomato phytonutrients to people who do not eat sufficient amounts of tomatoes or tomato products.

### EXAMPLES

### Example 1

### Preparation of Margarine with Lyc-O-Mato® 1%

Oils and fats are melted at 70° C. and then blended with Lyc-O-Mato® 1% (Lyc-O-Mato® 1% is a tomato oleoresin composition containing 1% lycopene) in a ratio of 150 g of Lyc-O-Mato® 1% per 100 kg of margarine. The blended mixture is then mixed with the aqueous phase and other ingredients employed in the preparation of the final margarine at 50-60° C. The mixture obtained then undergoes pre-crystallization using a chiller at 17-22° C. and 300-700 rpm. Crystallization using a pin worker at 300-700 rpm is then carried out prior to the final packaging.

### Example 2

### Preparation of Yogurt with Lyc-O-Mato® 10% or Lyc-O-Mato® Fibers

Milk is enriched in solids by addition of max 5% skim milk powder and Lyc-O-Mato® 10% (Lyc-O-Mato® 10% is a tomato oleoresin composition containing 10% lycopene) 240 g Lyc-O-Mato to in 1000 kg milk or Lyc-O-Mato® Fibers (2.4 kg/1000 kg milk). Protein and sugar are then added to increase the texture of the yogurt. The mixture obtained is then homogenized followed by heating in a plate exchanger at 90-95° C. for a very short period of about 5 to 10 sec., and then maintained for about 3-10 minutes at pasteurization temperature to improve the fermentation conditions. The mixture is then cooled to 42-44° C. and filled into containers while simultaneously adding the cultures. Fruit flavors are then added and the containers are stored a hot room at 42-44° C. for 2.5 to 5 hours. A low temperature slows down and stops the incubation. Yogurt is removed from the hot room and cooled before storing in a cold room at 2-4° C.

### Example 3

### Preparation of Bread with Lyc-O-Mato® Fibers

2.23 kg Lyc-O-Mato® Fibers, 159.3 kg water and 12.5 kg yeast are mixed together. 230 kg of flour, 5.06 kg salt, 14.88 kg sugar, 7.44 kg of margarine and 20 g vitamin C are then added and the entire mixture is blended to create a dough, which is maintained at 40° C. for 1 hr. The dough is baked at 230-235° C. and cooled to room temperature.

### Example 4

### Preparation of Frankfurter Sausages with Lyc-O-Mato® Fibers

Mixing spices, flavoring compositions and salt with Lyc-O-Mato® Fibers (500 g of Lyc-O-Mato® Fibers per 100 kg of sausages)
Blend 60 kg of meat (25% fat content) with 18 kg starch and 1.6 kg of carrageenan.
Add 10 kg of water and spices mix and blend.
Packing
Pre cooking

### Example 5

### Preparation of Chicken Burger with Lyc-O-Mato® Fibers

Ground chicken meat containing about 20% w/w water is flavored with onions, salt and spices, to which 0.5% (w/w of meat) Lyc-O-Mato® Fibers is added. The mixture obtained may then be cooked in a variety of forms, e.g. grilled patties.

### Example 6

### Preparation of Clear Grapefruit Beverage with Lyc-O-Mato® Fibers Microemulsion

The beverage is prepared by first preparing a microemulsion by mixing the following ingredients.

Microemulsion Preparation

| Component | Content, % |
|---|---|
| Simulsol 1294 (Hydrogenated castor oil PEG-60) | 10.42 |
| Oleoresin 2% (BN 005030) | 5.80 |
| Tocopherol acetate | 1.93 |
| Sugar ester PS750 | 1.93 |
| Water | 77.22 |
| Glycerol | 2.70 |

HPLC Analysis of Microemulsion:

| | |
|---|---|
| Lycopene | 0.085% |
| Phytoene | 0.049% |
| Phytofluene | 0.035% |

The microemulsion is then added to the beverage, mixed and bottled to obtain the final composition of the beverage as provided below:

Beverage

| Ingredient | Weight, kg |
|---|---|
| Grapefruit concentrate | 7.500 |
| Sugar syrup 75% | 32.5 (24.375 kg - sugar) |
| Citric acid 50% | 1.375 |
| Microemulsion 0.1% Lycopene | 5.200 |
| Pineapple Flavour 23078 | 0.110 |
| Orange Flavour 3355040 | 0.055 |
| Water | 219.375 |
| Total | 266 |

### Example 7

### Preparation of Margarine with Lyc-O-Mato® 5% Beadlets

The same procedure described in Example 1 is employed wherein the Lyc-O-Mato® 1% is substituted for Lyc-O-Mato® 5% beadlets (encapsulated beadlets of a tomato oleoresin composition which contains 5% lycopene) in a ratio of 300 g Lyc-O-Mato® 5% beadlets per 100 kg of margarine.

While embodiments of the invention have been described by way of illustration, it will be apparent that the invention may be carried out with many modifications, variations and adaptations, without departing from its spirit or exceeding the scope of the claims.

1. A method for fortifying food stuff with an effective health-beneficial amount of tomato phytonutrients comprising of adding to food stuff tomato oleoresin or tomato components thereof in an amount wherein the flavor of said food stuff are not substantially affected by said oleoresin or tomato component.

2. A method according to claim 1 wherein the tomato oleoresin or tomato components are in the form of a microemulsion, emulsion, beadlets, encapsulated form, composition comprising adjuvants or excipients, or a solution in oil.

3. A method according to claim 1 wherein said food stuff are selected from among food products or beverages including processed foods, baked products, dairy products and beverages.

4. A method according to claim 1 wherein the tomato component is added to the food stuff in the process of preparing said food stuff.

5. A method according to claim 1 wherein the tomato component is added to the food stuff subsequent to the preparation of the food stuff.

6. Food stuff fortified with tomato phytonutrients wherein the flavor of said food stuff is not substantially effected by the tomato phytonutrients.

7. Food stuff according to claim 6 wherein said food stuff are selected from among food products or beverages including processed foods, baked products, dairy products and beverages.

8. A method for obtaining the health benefits associated with the consumption of tomato phytonutrients, comprising of administering to a subject tomato-phytonutrient-fortified food stuff.

9. A method according to claim 8 wherein said health benefits are selected from among DNA damage prevention, blood pressure lowering, cardiovascular ailment prevention and free radical scavenging.

10. A method according to claim 8 wherein said food stuff provides a daily dosage of 0.5 to 20 mg lycopene.

11. A method for obtaining the health benefits associated with the consumption of tomato phytonutrients, comprising of administering to a subject tomato-phytonutrient-fortified food stuff wherein said tomato-phytonutrient-fortified food stuff are obtained according to claim 1.

12. A method for obtaining the health benefits associated with the consumption of tomato phytonutrients, comprising of administering to a subject tomato-phytonutrient-fortified food stuff and administering to a subject a tomato-phytonutrient-fortified food stuff as claimed in claim 6.

13. A method for obtaining the health benefits associated with the consumption of tomato phytonutrients, comprising of administering to a subject tomato-phytonutrient-fortified food stuff wherein said tomato-phytonutrient-fortified food stuff are obtained according to claim 2.

14. A method for obtaining the health benefits associated with the consumption of tomato phytonutrients, comprising of administering to a subject tomato-phytonutrient-fortified food stuff wherein said tomato-phytonutrient-fortified food stuff are obtained according to claim 3.

15. A method for obtaining the health benefits associated with the consumption of tomato phytonutrients, comprising of administering to a subject tomato-phytonutrient-fortified food stuff wherein said tomato-phytonutrient-fortified food stuff are obtained according to claim 4.

16. A method for obtaining the health benefits associated with the consumption of tomato phytonutrients, comprising of administering to a subject tomato-phytonutrient-fortified food stuff wherein said tomato-phytonutrient-fortified food stuff are obtained according to claim 5.

17. A method for obtaining the health benefits associated with the consumption of tomato phytonutrients, comprising of administering to a subject tomato-phytonutrient-fortified food stuff and administering to a subject a tomato-phytonutrient-fortified food stuff as claimed in claim 7.
